(19) United States
(12) Patent Application Publication
(10) Pub. No.: US 2008/0144267 A1
(43) Pub. Date: Jun. 19, 2008

(54) ELECTRONIC APPARATUS

(75) Inventors: Hiroyuki Tanaka, Kawasaki (JP); Yoshifumi Kajiwara, Kawasaki (JP); Hiroaki Sakashita, Kawasaki (JP); Yoshiya Matsumoto, Kawasaki (JP); Kazunori Murayama, Kawasaki (JP); Atsuko Yamamoto, Kawasaki (JP); Takehisa Ishikawa, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/943,944

(22) Filed: Nov. 21, 2007

(30) Foreign Application Priority Data
Dec. 15, 2006 (JP) 2006-339256

(51) Int. Cl. G06F 1/16

(52) U.S. Cl. 361/681

(57) ABSTRACT

An electronic apparatus of the clamshell type includes a hinge bracket receiving the back surface of a display enclosure. The hinge bracket takes a closed attitude, where the display enclosure is superposed on a main body enclosure, to an opened attitude, where the display enclosure is flipped to open relative to the main body enclosure. When the display enclosure is set at a specific angle position during establishment of the closed attitude of the hinge bracket, the screen of the display panel is partly uncovered outside the edge of the main body enclosure. The user of the electronic apparatus is allowed to look at an image or images on a partial screen. Such a partial screen provides the functions identical to those of a so-called sub-display panel. A conventional sub-display can be omitted. The electronic apparatus is allowed to enjoy a wide variety of design.

### BACKGROUND OF THE INVENTION

1. Field of the Invention

The present invention relates to an electronic apparatus such as a cellular or mobile phone terminal. In particular, the present invention relates to an electronic apparatus including a main body enclosure and a display enclosure superposed on the flat front surface of the main body enclosure, the display enclosure defining in the front surface a window opening for exposure of the screen of a display panel.

2. Description of the Prior Art

Some cellular or mobile phone terminals of the clamshell type include a main display and a sub-display as well known. A display panel of the main display is embedded in the front surface of a display enclosure. A display panel of the sub-display is embedded in the back surface of the display enclosure. When the mobile phone terminal takes the closed attitude, the screen of the main display is entirely covered with a main body enclosure. The sub-display serves to display the time, the reception of an incoming call or e-mail, and the like, on the screen of the display panel. The user of the mobile phone terminal is allowed to check the time, the reception of an incoming call or e-mail, and the like, without flipping to open the mobile phone terminal.

While such a sub-display provides useful functions, the mobile phone terminal is forced to suffer from a limited design resulting from the sub-display. When the sub-display is omitted, the mobile phone terminal would enjoy a wide variety of design. Accordingly, a technique is required to provide the functions of the sub-display without utilizing the sub-display.

### SUMMARY OF THE INVENTION

It is accordingly an object of the present invention to provide an electronic apparatus capable of omitting a sub-display without losing the functions of a sub-display.

According to a first aspect of the present invention, there is provided an electronic apparatus comprising: a main body enclosure; a display enclosure superposed on a flat front surface of the main body enclosure on its front surface, the display enclosure defining a window opening in the front surface for exposing the screen of a display panel; a hinge bracket coupled to the main body enclosure for relative rotation around a first rotation axis parallel to the flat front surface of the main body enclosure, the hinge bracket receiving the back surface of the display enclosure on the front surface of the hinge bracket, the hinge bracket allowed to change from a closed attitude, where the display enclosure is superposed on the flat front surface of the main body enclosure, to an opened attitude, where the display enclosure is flipped to open relative to the main body enclosure through rotation around the first rotation axis; and a coupling mechanism coupling the display enclosure to the hinge bracket for relative rotation around a second rotation axis perpendicular to the flat front surface of the main body enclosure when the hinge bracket takes the closed attitude, the coupling mechanism allowing rotation of the display enclosure around the second rotation axis at least over a range of 90 degrees from a reference angle position where the window opening of the display enclosure is entirely covered with the main body enclosure, the coupling mechanism restraining the rotation of the display enclosure around the second rotation axis at a specific angle position shifted from the reference angle position by an angle smaller than 90 degrees, to uncover the screen of the display panel outside the edge of the main body enclosure.

When the display enclosure is set at the reference angle position through the rotation around the second rotation axis, the screen of the display panel is covered with the main body enclosure during establishment of the closed attitude of the hinge bracket. The screen of the display panel is thus protected. When the display enclosure is kept at the reference angle position during establishment of the opened attitude of the hinge bracket, the screen of the display panel is set adjacent to the flat front surface of the main body enclosure. The user of the electronic apparatus is allowed to look at the entire screen of the display panel. When the display enclosure is set at the specific angle position during establishment of the closed attitude of the hinge bracket, the screen of the display panel is partly uncovered outside the edge of the main body enclosure. The user of the electronic apparatus is allowed to look at an image or images on a partial screen. Such a partial screen is allowed to provide the functions identical to those of a so-called sub-display panel. A conventional sub-display can thus be omitted. The electronic apparatus is allowed to enjoy a wide variety of design.

The specific angle position may be shifted from the reference angle position by 45 degrees. Such inclination of 45 degrees contributes to an enhanced appearance of the electronic apparatus. The hinge bracket may have the contour aligned with the contour of the display enclosure when the display enclosure is set at the specific angle position during establishment of the closed attitude of the hinge bracket. Such a contour contributes to an enhanced appearance of the electronic apparatus.

The electronic apparatus may further comprise: a magnet attached to one of the hinge bracket and the display enclosure; a magnetic force sensor attached to the other of the hinge bracket and the display enclosure, the magnetic force sensor opposed to the magnet when the display enclosure is set at the specific angle position during establishment of the closed attitude of the hinge bracket; and a controller circuit outputting an instruction signal to clear display on the screen of the display panel when the controller circuit detects the display panel set at the reference angle position during establishment of the closed attitude of the hinge bracket in response to the output from the magnetic force sensor, the controller circuit outputting an instruction signal to make a specific display appear on an uncovered screen of the display panel outside the edge of the main body enclosure when the controller circuit detects the display enclosure set at the specific angle position during establishment of the closed attitude of the hinge bracket in response to output from the magnetic force sensor.

The electronic apparatus allows an image or images to reliably appear on the partial screen when the display enclosure is set at the specific angle position. Such a partial screen can reliably provide the functions identical to those of a conventional sub-display.

According to a second aspect of the present invention, there is provided an electronic apparatus comprising: a main body enclosure; a display enclosure superposed on a flat front surface of the main body enclosure on its front surface, the display enclosure defining a window opening in the front surface for exposing the screen of a display panel; a hinge bracket coupled to the main body enclosure for relative rotation around a first rotation axis parallel to the flat front surface of the main body enclosure, the hinge bracket receiving the back surface of the display enclosure on the front surface of the hinge bracket, the hinge bracket allowed to change from a closed attitude, where the display enclosure is superposed on the flat front surface of the main body enclosure, to an opened attitude, where the display enclosure is flipped to open relative to the main body enclosure through rotation around the first rotation axis; and a coupling mechanism coupling the display enclosure to the hinge bracket for relative rotation around a second rotation axis perpendicular to the flat front surface of the main body enclosure when the hinge bracket takes the closed attitude, the coupling mechanism allowing rotation of the display enclosure around the second rotation axis in normal and reverse directions at least over a range of 90 degrees, respectively, from a reference angle position where the window opening of the display enclosure is entirely covered with the main body enclosure, the coupling mechanism restraining the rotation of the display enclosure at specific angle positions shifted from the reference angle position by an angle smaller than 90 degrees in the normal and reverse directions, respectively, to uncover the screen of the display panel outside the edge of the main body enclosure.

When the display enclosure is set at the reference angle position through the rotation around the second rotation axis, the screen of the display panel is covered with the main body enclosure during establishment of the closed attitude of the hinge bracket. The screen of the display panel is thus protected. When the display enclosure is kept at the reference angle position during establishment of the opened attitude of the hinge bracket, the screen of the display panel is set adjacent to the flat front surface of the main body enclosure. The user of the electronic apparatus is allowed to look at the entire screen of the display panel. When the display enclosure is set at the specific angle position during establishment of the closed attitude of the hinge bracket, the screen of the display panel is partly uncovered outside the edge of the main body enclosure. The user of the electronic apparatus is allowed to look at an image or images on a partial screen. Such a partial screen is allowed to provide the functions identical to those of a so-called sub-display panel. A conventional sub-display can thus be omitted. The electronic apparatus is allowed to enjoy a wide variety of design. In addition, the display enclosure can be set at the specific position through the rotation in either the normal or reverse direction.

In this case, the specific angle positions may be shifted from the reference angle position by ±45 degrees in the same manner as describe above. The hinge bracket may have the contour aligned with the contour of the display enclosure when the display enclosure is set at any of the specific angle positions during establishment of the closed attitude of the hinge bracket. The electronic apparatus may further comprise: a magnet attached to one of the hinge bracket and the display enclosure; a magnetic force sensor attached to the other of the hinge bracket and the display enclosure, the magnetic force sensor opposed to the magnet when the display enclosure is set at the specific angle position during establishment of the closed attitude of the hinge bracket; and a controller circuit outputting an instruction signal to clear display on the screen of the display panel when the controller circuit detects the display panel set at the reference angle position during establishment of the closed attitude of the hinge bracket in response to the output from the magnetic force sensor, the controller circuit outputting an instruction signal to make a specific display appear on an uncovered screen of the display panel outside the edge of the main body enclosure when the controller circuit detects the display enclosure set at the specific angle position during establishment of the closed attitude of the hinge bracket in response to output from the magnetic force sensor.

According to a third aspect of the present invention, there is provided an electronic apparatus comprising: a main body enclosure; a display enclosure superposed on a flat front surface of the main body enclosure on its front surface, the display enclosure defining a window opening in the front surface for exposing the screen of a display panel; a first coupling mechanism coupling the display enclosure to the main body enclosure for relative rotation around a first rotation axis parallel to the flat front surface of the main body enclosure, the first coupling mechanism allowing change of the attitude of the display enclosure from a closed attitude, where the display enclosure is superposed on the flat front surface of the main body enclosure, to an opened attitude, where the display enclosure is flipped to open relative to the main body enclosure through rotation around the first rotation axis; and a second coupling mechanism coupling the display enclosure to the main body enclosure for relative rotation around a second rotation axis perpendicular to the flat front surface of the main body enclosure when the display enclosure takes the closed attitude, the second coupling mechanism allowing rotation of the display enclosure around the second rotation axis at least over a range of 90 degrees from a reference angle position where the window opening of the display enclosure is entirely covered with the main body enclosure, the second coupling mechanism restraining the rotation of the display enclosure at a specific angle position shifted from the reference angle position by an angle smaller than 90 degrees, to uncover the screen of the display panel outside the edge of the main body enclosure.

When the display enclosure is set at the reference angle position through the rotation around the second rotation axis, the screen of the display panel is covered with the main body enclosure during establishment of the closed attitude of the display enclosure. The screen of the display panel is thus protected. When the display enclosure is kept at the reference angle position during establishment of the opened attitude of the display enclosure, the screen of the display panel is set adjacent to the flat front surface of the main body enclosure. The user of the electronic apparatus is allowed to look at the entire screen of the display panel. When the display enclosure is set at the specific angle position during establishment of the closed attitude of the display enclosure, the screen of the display panel is partly uncovered outside the edge of the main body enclosure. The user of the electronic apparatus is allowed to look at an image or images on a partial screen. Such a partial screen is allowed to provide the functions identical to those of a so-called sub-display panel. A conventional sub-display can thus be omitted. The electronic apparatus is allowed to enjoy a wide variety of design.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view schematically illustrating a cellular or mobile phone terminal of the clamshell type according to an embodiment of the present invention;

FIG. 2 is a perspective view of the mobile phone terminal for schematically illustrating a display enclosure set in an opened attitude;

FIG. 3 is a plan view of the back surface of the display enclosure for schematically illustrating a second coupling mechanism;

FIG. 4 is a plan view of the front surface of a hinge bracket for schematically illustrating an auxiliary lock mechanism;

FIG. 5 is a plan view of the display enclosure and hinge bracket for schematically illustrating a rotation angle detection mechanism on the hinge bracket;

FIG. 6 is a schematic side view of a main body enclosure and the display enclosure for illustrating an opening/closing detection mechanism;

FIG. 7 is a block diagram schematically illustrating a control system related to a liquid crystal display (LCD) panel;

FIG. 8 is a front view of the mobile phone terminal for schematically illustrating the display enclosure in the opened attitude, the display enclosure rotating around a second rotation axis in the normal direction by 90 degrees;

FIG. 9 is a schematic view of the hinge bracket for illustrating the second coupling mechanism, the auxiliary lock mechanism and the rotation angle detection mechanism when the display enclosure is set at a maximum rotation angle position through the rotation around the second rotation axis;

FIG. 10 is a front view of the mobile phone terminal for schematically illustrating the display enclosure in the opened attitude, the display enclosure rotating around the second rotation axis in the reverse direction by 90 degrees;

FIG. 11 is a backside view of the mobile phone terminal for schematically illustrating the display enclosure in the closed attitude, the display enclosure rotating around the second rotation axis in the normal direction by 45 degrees;

FIG. 12 is a schematic view of the surface of the hinge bracket for illustrating the second coupling mechanism, the auxiliary lock mechanism and the rotation angle detection mechanism when the display enclosure is set at a specific angle position through rotation around the second rotation axis; and

FIG. 13 is a backside view of the mobile phone terminal for schematically illustrating the display enclosure in the closed attitude, the display enclosure rotating around the second rotation axis in the reverse direction by 45 degrees.

### DESCRIPTION OF THE PREFERRED EMBODIMENT

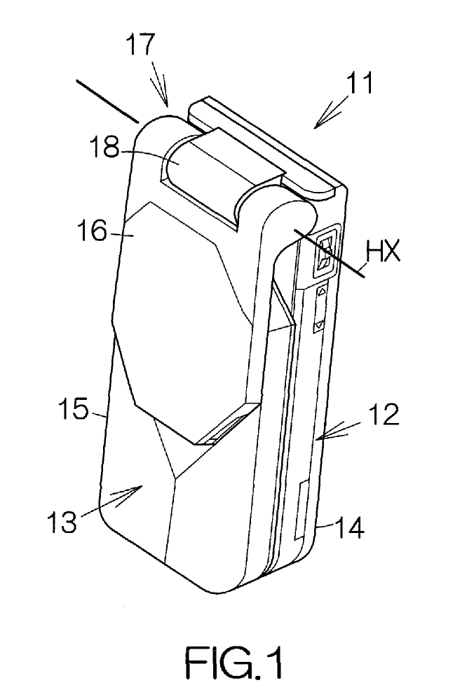

FIG. 1 schematically illustrates a cellular or mobile phone terminal 11 of the clamshell type as an example of an electronic apparatus according to an embodiment of the present invention. The mobile phone terminal 11 includes a main apparatus 12 and a display unit 13. The main apparatus 12 includes a main body enclosure 14 serving as a first enclosure. A printed circuit board, not shown, is incorporated in the main body enclosure 14. Processing circuits, such as a central processing unit (CPU) and a memory, are mounted on the printed circuit board in a conventional manner. The main body enclosure 14 may be molded from a reinforced resin material such as acrylonitrile butadiene styrene (ABS), for example.

The display unit 13 includes a display enclosure 15 serving as a second enclosure. The display enclosure 15 can be superposed on the flat front surface of the main body enclosure 14. The front surface of the display enclosure 15 meets with the front surface of the main body enclosure 14. The contour of the display enclosure 15 matches that of the main body enclosure 14. The front surface of the display enclosure 15 is thus entirely covered with the main body enclosure 14. The display enclosure 15 may be molded from a reinforced resin material such as acrylonitrile butadiene styrene (ABS), for example.

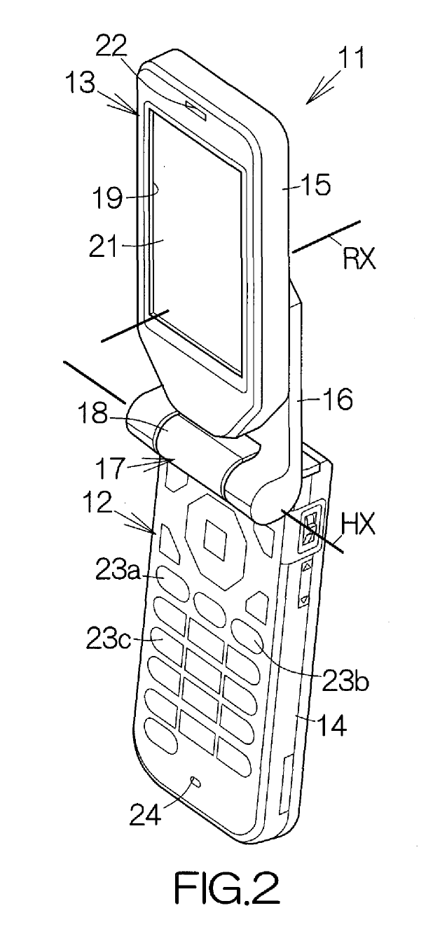

A hinge bracket 16 is coupled to the display enclosure 15. The hinge bracket 16 is also coupled to the main body enclosure 14. A first coupling mechanism 17 is utilized to couple the hinge bracket 16 to the main body enclosure 14. The first coupling mechanism 17 includes a hinge 18. The hinge 18 serves to realize relative rotation between the main body enclosure 14 and the hinge bracket 16 around a first rotation axis HX. The hinge bracket 16 is thus coupled to the main body enclosure 14 for relative rotation around the first rotation axis HX. The first rotation axis HX is designed to extend along a line parallel to the flat front surface of the main body enclosure 14. As is apparent from FIG. 2, the hinge bracket 16 is allowed to change from a closed attitude to an opened attitude. When the hinge bracket 16 takes the closed attitude, the display enclosure 15 is superposed on the flat front surface of the main body enclosure 14. When the hinge bracket 16 takes the opened attitude, the display enclosure 15 is flipped to open relative to the main body enclosure 14 through the rotation around the first rotation axis HX. The display enclosure 15 thus changes the attitude between the closed attitude and the opened attitude.

As shown in FIG. 2, a rectangular window opening 19 is defined in the front surface of the display enclosure 15. A flat display panel such as a liquid crystal display (LCD) panel 21 is incorporated in the display enclosure 15. The screen of the LCD panel 21 is placed within the window opening 19. Various texts and graphics are displayed on the screen of the LCD panel 21 in response to the operation of the CPU. A speaker hole 22 is defined in the front surface of the display enclosure 15. A speaker is placed within the speaker hole 22. The speaker reproduces the voice of the other party during telephone conversation.

Keypads, such as an on-hook keypad 23a, an off-hook keypad 23b, numeric keypads 23c and the like, are embedded in the flat front surface of the main apparatus 12. The CPU executes various processing in response to the manipulation of the keypads. A microphone hole 24 is defined in the flat front surface of the main body enclosure 14. A microphone is placed within the microphone hole 24. The user of the mobile phone terminal 11 speaks to the microphone for telephone conversation.

The hinge bracket 16 supports or receives the back surface of the display enclosure 15 on its front surface. The back surface of the display enclosure 15 meets with the front surface of the hinge bracket 16. The display enclosure 15 is coupled to the hinge bracket 16 for relative rotation around a second rotation axis RX. The second rotation axis RX is designed to extend within an imaginary plane perpendicular to the first rotation axis HX. The second rotation axis RX is also designed to intersect with the surface of the hinge bracket 16. Here, the intersecting angle is set at 90 degrees. The display enclosure 15 is in this manner allowed to rotate relative to the main body enclosure 14 around the first rotation axis HX.

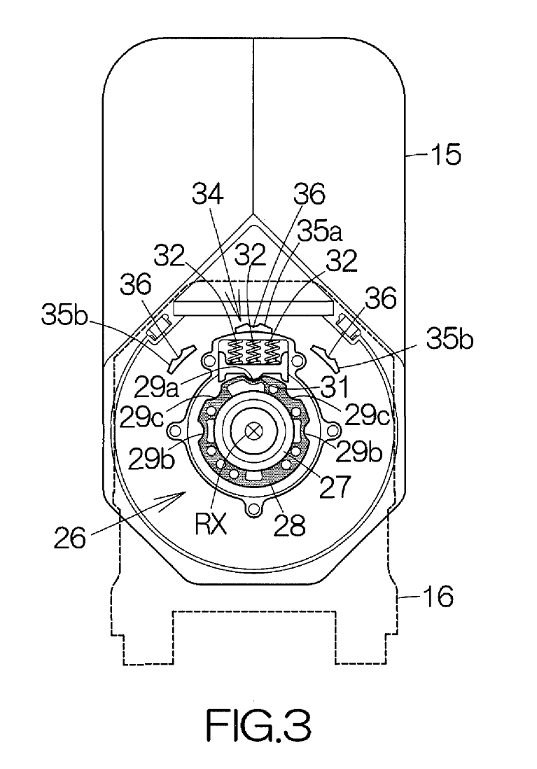

As shown in FIG. 3, a second coupling mechanism 26 is incorporated in the back surface of the display enclosure 15. The second coupling mechanism 26 includes a hollow cylindrical shaft 27 designed to extend concentrically with the second rotation axis RX. The hollow cylindrical shaft 27 is stationarily fixed to the display enclosure 15. An annular member 28 is mounted on the hollow cylindrical shaft 27 for relative rotation around the hollow cylindrical shaft 27. The annular member 28 is prevented from an axial movement relative to the hollow cylindrical shaft 27. Specifically, the annular member 28 is prevented from falling off. The hinge bracket 16 is fixed to the annular member 28. Relative rotation is restrained between the hinge bracket 16 and the annular member 28 around the hollow cylindrical shaft 27. Relative rotation between the hollow cylindrical shaft 27 and the annular member 28 thus enables relative rotation between the display enclosure 15 and the hinge bracket 16.

Five depressions 29a, 29b, 29b, 29c, 29c are formed on the outer periphery of the annular member 28 at constant intervals of the central angle of 45 degrees. The depressions 29a, 29b, 29c are depressed toward the central axis of the hollow cylindrical shaft 27, namely the second rotation axis RX. The depressions 29a, 29b, 29c are respectively defined based on arched edges of the annular member 28, for example. An arched protrusion 31 is opposed to the outer periphery of the annular member 28. Three tensile springs 32 are utilized to urge the protrusion 31 toward the central axis of the hollow cylindrical shaft 27, namely the second rotation axis RX, for example. The protrusion 31 is received in one of the depressions 29a, 29b, 29c. The depression 29a at the middle position of the arrangement determines a reference angle position. When the protrusion 31 is received in the first depression 29a, the display enclosure 15 is set at the reference angle position as described later. The depressions 29b, 29b at the opposite end positions of the arrangement determine the maximum rotation angle positions corresponding to the central angles of ±90 degrees from the reference angle position, respectively. When the protrusion 31 is received in one of the second depressions 29b, 29b, the display enclosure 15 is set at the maximum rotation angle position as described later. The third depressions 29c, 29c adjacent to the first depression 29a determine specific angle positions according to the present invention. Here, the specific angle positions correspond to the central angles of ═45 degrees, respectively. When the protrusion 31 is received in one of the third depressions 29c, 29c, the display enclosure 15 is set at a specific angle position as described later. A combination of the protrusion 31 and the depressions 29a, 29b, 29c thus enables restraint of the rotation of the display enclosure 15 at the reference angle position, the positions shifted from the reference angle position by the central angle of 45 degrees in the normal and reverse directions, respectively, and the positions shifted from the reference angle position by the central angle of 90 degrees in the normal and reverse direction, respectively.

An auxiliary lock mechanism 34 is established between the display enclosure 15 and the hinge bracket 16. The auxiliary lock mechanism 34 includes three restraining pieces 35a, 35b, 35b formed on the back surface of the display enclosure 15. The restraining pieces 35a, 35b are arranged on an imaginary circle concentric with the second rotation axis RX at constant intervals of the central angle of 45 degrees. A depression 36 is formed on each of the restraining pieces 35a, 35b. The depressions 36 are depressed toward the second rotation axis RX. The depression 36 of the restraining piece 35a at the middle position of the arrangement of the restraining pieces 35a, 35b and the first depression 29a are aligned on a radial line of an imaginary circle concentric with the central axis of the hollow cylindrical shaft 27, namely the second rotation axis RX. The restraining pieces 35b at the opposite end positions of the arrangement of the restraining pieces 35a, 35b and the third depressions 29c are thus respectively aligned on a radial line of the imaginary circle concentric with the central axis of the hollow cylindrical shaft 27, namely the second rotation axis RX.

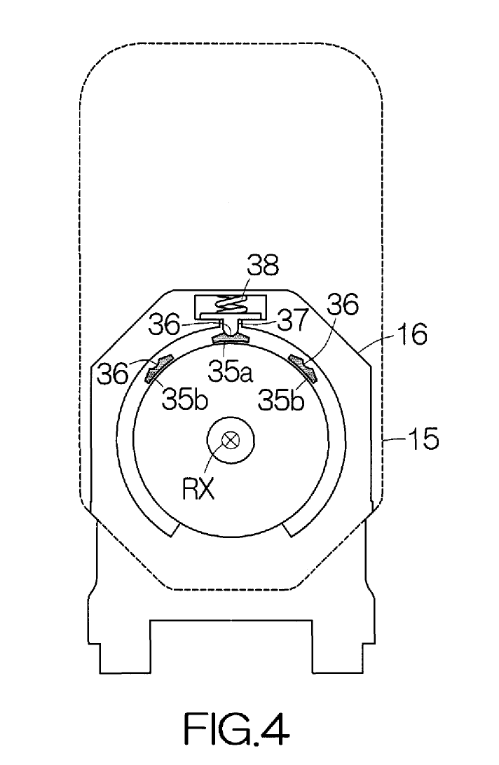

As shown FIG. 4, a locking pin 37 is placed at a position outside the imaginary circle on which the restraining pieces 35a, 35b are located. The locking pin 37 is attached to the hinge bracket 16. The locking pin 37 is designed to realize the forward movement and the backward movement on the radial line of the imaginary circle. A tensile spring 38 is utilized to urge the locking pin toward the second rotation axis RX, for example. The tip end of the locking pin 37 is received in the depression 36. The tip end of the locking pin 37 has the shape reflecting the shape of the depression 36. A combination of the locking pin 37 and the depressions 36 thus serves to reinforce the restraint of relative rotation between the display enclosure 15 and the hinge bracket 16.

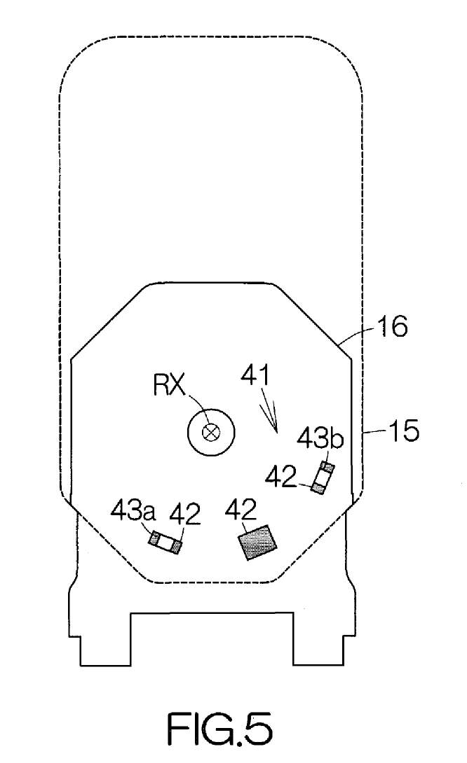

As shown in FIG. 5, a rotation angle detection mechanism 41 is established between the display enclosure 15 and the hinge bracket 16. The rotation angle detection mechanism 41 includes three magnets 42 attached on the hinge bracket 16. The magnets 42 are arranged along an imaginary circle concentric with the central axis of the hollow cylindrical shaft 27, namely the second rotation axis RX, at constant intervals of the central angle of 45 degrees, for example.

First and second magnetic force sensors 43a, 43b are attached to the display enclosure 15. The magnetic force sensors 43a, 43b are arranged along an imaginary circle concentric with the central axis of the hollow cylindrical shaft 27, namely the second rotation axis RX at constant intervals of the central angle of 90 degrees, for example. When the display enclosure 15 is set at the reference angle position based on the action of the second coupling mechanism 26, the first and second magnetic force sensors 43a, 43b are respectively opposed to the magnets 42 at the opposite end positions of the arrangement of the magnets 42. It should be noted that the magnets 42 of the rotation angle detection mechanism 41 may be attached to the display enclosure 15. In this case, the first and second magnetic force sensors 43a, 43b may correspondingly be attached to the hinge bracket 16.

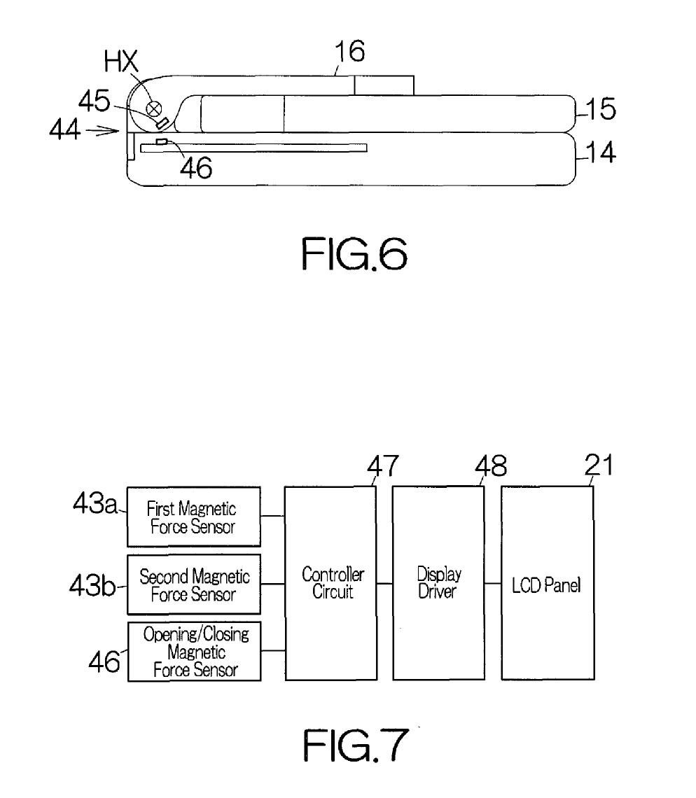

As shown in FIG. 6, an opening/closing detection mechanism 44 is established between the main body enclosure 14 and the hinge bracket 16. The opening/closing detection mechanism 44 includes a magnet 45 attached to one of the main body enclosure 14 and the hinge bracket 16. An opening/closing magnetic force sensor 46 is attached to the other of the main body enclosure 14 and the hinge bracket 16. The magnet 45 and the opening/closing magnetic force sensor 46 are located within an imaginary plane perpendicular to the first rotation axis HX, for example. When the hinge bracket 16 takes the closed attitude through the rotation of the hinge bracket 16 around the first rotation axis HX, the opening/closing magnetic force sensor 46 gets opposed to the magnet 45. The opening/closing magnetic force sensor 46 outputs a detection signal in response to the magnetic force of the magnet 45.

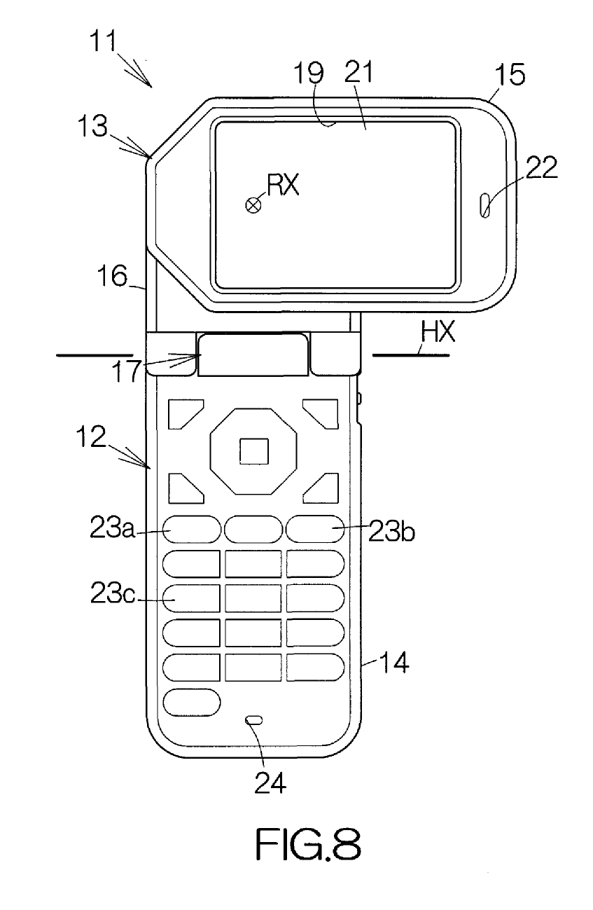

As shown in FIG. 7, the first and second magnetic force sensors 43, 43b and the opening/closing magnetic force sensor 46 are connected to a controller circuit 47. When the first and second magnetic force sensors 43a, 43b detects magnetic force, the magnetic force sensors 43a, 43b output a detection signal to the controller circuit 47. Likewise, when the opening/closing magnetic force sensor 46 detects magnetic force, the opening/closing magnetic force sensor 46 outputs a detection signal to the controller circuit 47.

A display driver 48 is connected to the controller circuit 47. The LCD panel 21 is connected to the display driver 48. The display driver 48 is designed to control the display on the LCD panel 21 in response to an instruction signal supplied from the controller circuit 47. The controller circuit 47 generates the instruction signal in response to the detection signals output from the first and second magnetic force sensors 43, 43b and the opening/closing magnetic force sensor 46.

Now, assume that the display enclosure 15 is set at the reference angle position based on the action of the second coupling mechanism 26. As is apparent from FIG. 3, the protrusion 31 is received in the first depression 29a of the annular member 28 in the second coupling mechanism 26. The protrusion 31 is urged into the first depression 29a based on the action of the tensile springs 32. The annular member 28, namely the display enclosure 15 is restrained from rotating around the second rotation axis RX. The tip end of the locking pin 37 is received in the depression 36 of the corresponding restraining piece 35a at the middle position in the auxiliary lock mechanism 34. The locking pin 37 is urged into the depression 36 with the assistance of the tensile spring 38. The restraint of the relative rotation is reinforced between the annular member 28, namely the display enclosure 15, and the hinge bracket 16 around the second rotation axis RX. As is apparent from FIG. 5, the first magnetic force sensor 43a is opposed to the magnet 42. Likewise, the second magnetic force sensor 43b is opposed to the magnet 42. Detection signals are supplied to the controller circuit 47 from the first and second magnetic force sensors 43a, 43b at the same time.

When the display unit 13, namely the display enclosure 15 takes the opened attitude through rotation around the first rotation axis HX, the main apparatus 12 and the display unit 13 face front, as shown in FIG. 2. The LCD panel 21 realizes the portrait screen while the main apparatus 12 takes the vertical attitude. The user of the mobile phone terminal 11 is allowed to look at the keypads such as the numeric keypads 15c while he/she keeps looking at the portrait screen of the LCD panel 21. In this case, the opening/closing magnetic force sensor 46 is distanced from the magnet 46. No detection signal is output from the opening/closing magnetic force sensor 46. A portrait image is displayed on the portrait screen of the LCD panel 21 in response to an instruction signal from the controller circuit 47, for example.

When the display enclosure 15 takes the opened attitude, the display enclosure 15 is allowed to rotate around the second rotation axis RX. When the display enclosure 15 rotates from the reference angle position in the clockwise direction, namely in the normal direction, by 90 degrees, for example, the display enclosure 15 is set at the maximum rotation angle position, as shown in FIG. 8. The LCD panel 21 realizes the landscape screen while the main apparatus 12 still takes the vertical attitude. The user of the mobile phone terminal 11 can enjoy the display of texts and graphics on the landscape screen.

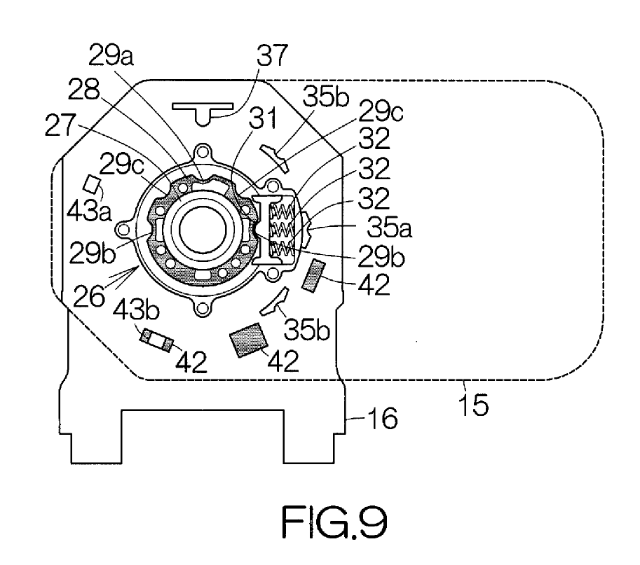

In this case, the protrusion 31 is received in the second depression 29b of the annular member 28 in the second coupling mechanism 26, as shown in FIG. 9. The protrusion 31 is urged into the second depression 29b with the assistance of the tensile springs 32. The annular member 28, namely the display enclosure 15 is restrained from rotating around the second rotation axis RX. The tip end of the locking pin 37 is disengaged from all of the restraining pieces 35a, 35b in the auxiliary lock mechanism 34. The first magnetic force sensor 43a is distanced from the magnet 42. The second magnetic force sensor 43b sequentially passes by the magnets 42. The second magnetic force sensor 43b outputs detection signals to the controller circuit 47. Since no detection signal is supplied from the first magnetic force sensor 43a, the controller circuit 47 is invited to detect the display enclosure 15 set at the maximum rotation angle position through the rotation around the second rotation axis RX in the normal direction. A landscape image is displayed on the landscape screen of the LCD panel 21 in response to an instruction signal from the controller circuit 47.

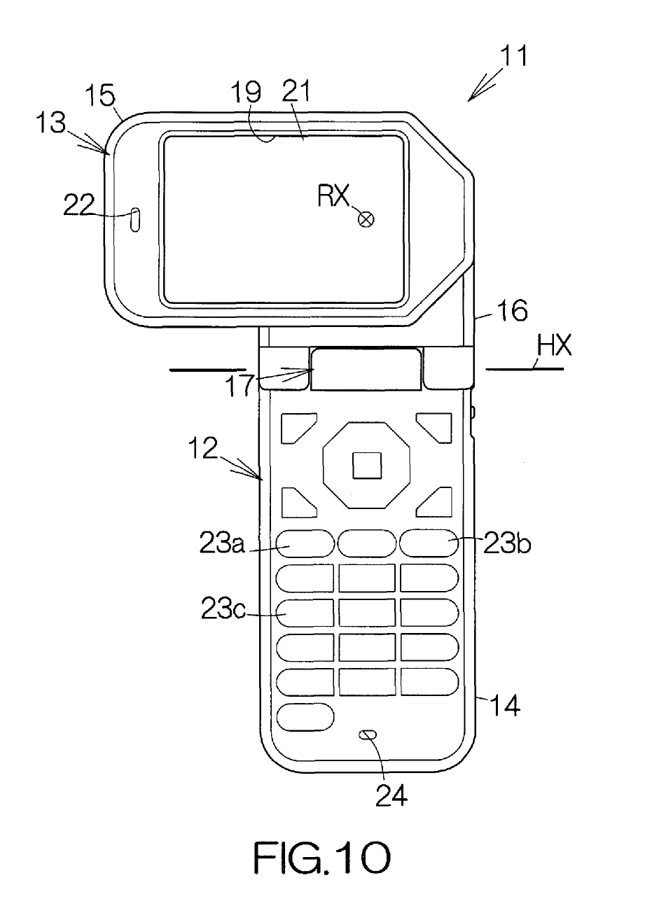

When the display enclosure 15 rotates from the reference angle position in the anticlockwise direction, namely in the reverse direction, by 90 degrees, for example, the display enclosure 15 is set at the maximum rotation angle position, as shown in FIG. 10. The LCD panel 21 realizes the landscape screen while the main apparatus 12 takes the vertical attitude. The protrusion 31 is received in the second depression 29b of the annular member 28 in the second coupling mechanism 26 in the same manner as described above. The tip end of the locking pin 37 is disengaged from all of the restraining pieces 35a, 35b in the auxiliary lock mechanism 34. The second magnetic force sensor 43b is distanced from the magnet 42. The first magnetic force sensor 43a sequentially passes by the magnets 42. Since no detection signal is supplied from the second magnetic force sensor 43b, the controller circuit 47 is invited to detect the display enclosure 15 set at the maximum rotation angle position through the rotation around the second rotation axis RX in the reverse direction.

Next, assume that the display enclosure 15 takes the closed attitude through the rotation around the first rotation axis HX while the display enclosure 15 is kept at the reference angle position. As shown in FIG. 1, the display enclosure 15 is superposed on the flat front surface of the main body enclosure 14. The mobile phone terminal 11 is thus closed. The closed attitude is established. The main body enclosure 14 completely covers over the window opening 19 of the display enclosure 15, namely the screen of the LCD panel 21.

The opening/closing magnetic force sensor 46 is opposed to the magnet 45. The opening/closing magnetic force sensor 46 outputs a detection signal. The controller circuit 47 receives the detection signals output from the first and second magnetic force sensors 43a, 43b and the opening/closing magnetic force sensor 46 at the same time. The controller circuit 47 supplies an instruction signal to the display driver 48 for clearing an image or images on the screen. The display driver 48 operates to clear an image or images on the screen of the LCD panel 21 in response to the supplied instruction signal. The LCD panel 21 may then be switched off. A purposeless display is avoided. This results in reduction in the consumption of electric power.

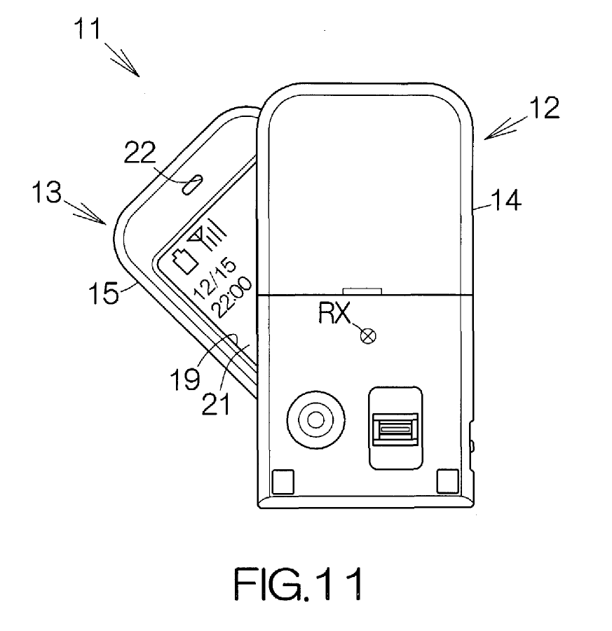

The display enclosure 15 can rotate around the second rotation axis RX during the establishment of the closed attitude of the display enclosure 15. When the display enclosure 15 rotates from the reference angle position in the clockwise direction, namely in the normal direction, by 45 degrees, for example, the display enclosure 15 is set at the specific angle position, as shown in FIG. 11. The LCD panel 21 is inclined relative to the main apparatus 12 in the vertical attitude. The screen of the LCD panel 21 is partly uncovered outside the edge of the main body enclosure 14. The user of the mobile phone terminal 11 can see texts and graphics on an exposed triangle screen, a part of the rectangle screen, at the corner of the rectangle screen.

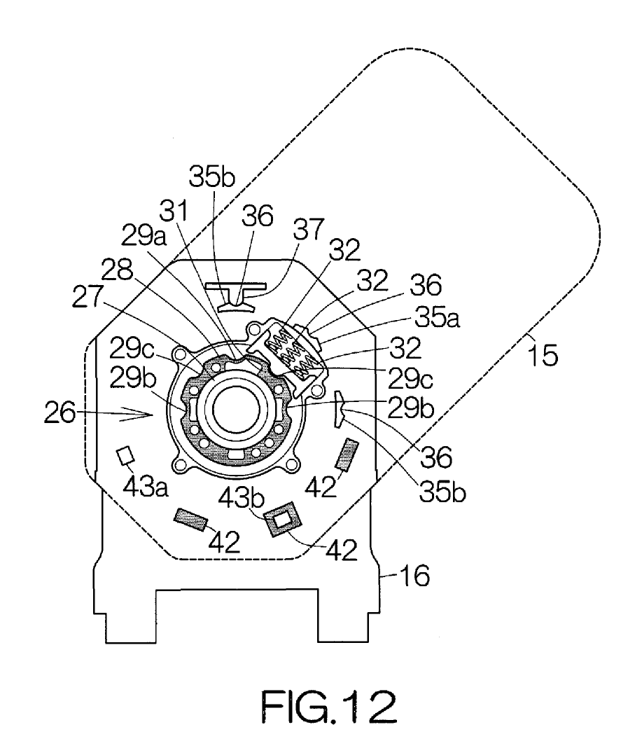

In this case, the protrusion 31 is received in the third depression 29c of the annular member 28 in the second coupling mechanism 26, as shown in FIG. 12, for example. The protrusion 31 is urged into the third depression 29c based on the action of the tensile springs 32. The annular member 28, namely the display enclosure 15, is restrained from rotating around the second rotation axis RX. The tip end of the locking pin 37 is received in the depression 36 of the restraining piece 35b in the auxiliary lock mechanism 34. The locking pin 37 is urged into the depression 36 with the assistance of the tensile spring 38. The restraint of the relative rotation is reinforced between the annular member 28, namely the display enclosure 15 and the hinge bracket 15 around the second rotation axis RX. Here, the contour of the display enclosure 15 partly aligned with that of the hinge bracket 16. The mobile phone terminal 11 is thus allowed to enjoy an enhanced appearance.

The first magnetic force sensor 43a is distanced from the magnet 42. Simultaneously, the second magnetic force sensor 43b is opposed to the magnet 42 at the middle position. A detection signal is supplied to the controller circuit 47 from the second magnetic force sensor 43b. The first magnetic force sensor 43a fails to output a detection signal. Accordingly, the controller circuit 47 is invited to detect the display enclosure 15 set at the specific rotation angle position through the rotation around the second rotation axis RX in the normal direction. The controller circuit 47 operates to display an image or images on the exposed triangle screen. The image or images are designed to correspond to the exposed triangle screen. The image or images include texts and graphics showing the date, the time, the reception of an incoming call or e-mail, signal strength, the remaining battery level, and the like, for example.

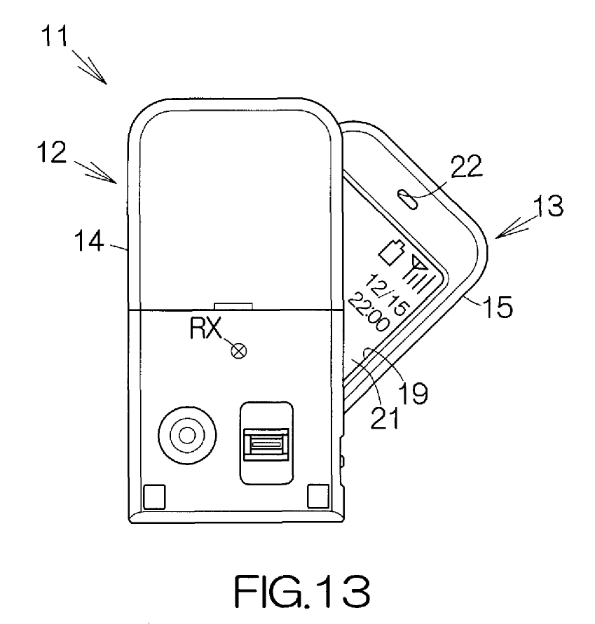

When the display enclosure 15 rotates from the reference angle position in the anticlockwise direction, namely in the reverse direction, by 45 degrees, for example, the display enclosure 15 is set at the specific rotation angle position, as shown in FIG. 13. The LCD panel 21 is inclined relative to the main apparatus 12 in the vertical attitude. The protrusion 31 is received in the third depression 29c of the annular member 28 in the second coupling mechanism 26 in the same manner as described above. The tip end of the locking pin 37 is received in the depression 36 of the restraining piece 35b in the auxiliary lock mechanism 34. The second magnetic force sensor 43b is distanced from the magnet 42. The first magnetic force sensor 43a is opposed to the magnet 42 at the middle position. The second magnetic force sensor 43b fails to output a detection signal. Accordingly, the controller circuit 47 detects the display enclosure 15 set at the specific rotation angle position through rotation around the second rotation axis RX in the reverse direction.

When the display enclosure 15 takes the closed attitude through the rotation around the first rotation axis HX, the display enclosure 15 can be set at the specific rotation angle position through the rotation around the second rotation axis RX in the mobile phone terminal 11. The screen of the LCD panel 21 can thus be partially exposed. Such a partial screen can provide the functions identical to those of a so-called sub-display panel. A conventional sub-display panel can thus be omitted. The mobile phone terminal 11 is allowed to enjoy a wide variety of design.

What is claimed is:

1. An electronic apparatus comprising:
a main body enclosure;
a display enclosure superposed on a flat front surface of the main body enclosure on a front surface, the display enclosure defining a window opening in the front surface for exposing a screen of a display panel;
a hinge bracket coupled to the main body enclosure for relative rotation around a first rotation axis parallel to the flat front surface of the main body enclosure, the hinge bracket receiving a back surface of the display enclosure on a front surface, the hinge bracket allowed to change from a closed attitude, where the display enclosure is superposed on the flat front surface of the main body enclosure, to an opened attitude, where the display enclosure is flipped to open relative to the main body enclosure through rotation around the first rotation axis; and
a coupling mechanism coupling the display enclosure to the hinge bracket for relative rotation around a second rotation axis perpendicular to the flat front surface of the main body enclosure when the hinge bracket takes the closed attitude, the coupling mechanism allowing rotation of the display enclosure around the second rotation axis at least over a range of 90 degrees from a reference angle position where the window opening of the display enclosure is entirely covered with the main body enclosure, the coupling mechanism restraining the rotation of the display enclosure around the second rotation axis at a specific angle position shifted from the reference angle position by an angle smaller than 90 degrees, to uncover the screen of the display panel outside an edge of the main body enclosure.

2. The electronic apparatus according to claim 1, wherein the specific angle position is shifted from the reference angle position by 45 degrees.

3. The electronic apparatus according to claim 1, wherein the hinge bracket has a contour aligned with a contour of the display enclosure when the display enclosure is set at the specific angle position during establishment of the closed attitude of the hinge bracket.

4. The electronic apparatus according to claim 1, further comprising:
a magnet attached to one of the hinge bracket and the display enclosure;
a magnetic force sensor attached to other of the hinge bracket and the display enclosure, the magnetic force sensor opposed to the magnet when the display enclosure is set at the specific angle position during establishment of the closed attitude of the hinge bracket; and
a controller circuit outputting an instruction signal to clear display on the screen of the display panel when the controller circuit detects the display panel set at the reference angle position during establishment of the closed attitude of the hinge bracket in response to output from the magnetic force sensor, the controller circuit outputting an instruction signal to make a specific display appear on an uncovered screen of the display panel outside the edge of the main body enclosure when the controller circuit detects the display enclosure set at the specific angle position during establishment of the closed attitude of the hinge bracket in response to output from the magnetic force sensor.

5. An electronic apparatus comprising:
a main body enclosure;
a display enclosure superposed on a flat front surface of the main body enclosure on a front surface, the display enclosure defining a window opening in the front surface for exposing a screen of a display panel;
a hinge bracket coupled to the main body enclosure for relative rotation around a first rotation axis parallel to the flat front surface of the main body enclosure, the hinge bracket receiving a back surface of the display enclosure on a front surface, the hinge bracket allowed to change from a closed attitude, where the display enclosure is superposed on the flat front surface of the main body enclosure, to an opened attitude, where the display enclosure is flipped to open relative to the main body enclosure through rotation around the first rotation axis; and
a coupling mechanism coupling the display enclosure to the hinge bracket for relative rotation around a second rotation axis perpendicular to the flat front surface of the main body enclosure when the hinge bracket takes the closed attitude, the coupling mechanism allowing rotation of the display enclosure around the second rotation axis in normal and reverse directions at least over a range of 90 degrees, respectively, from a reference angle position where the window opening of the display enclosure is entirely covered with the main body enclosure, the coupling mechanism restraining the rotation of the display enclosure at specific angle positions shifted from the reference angle position by an angle smaller than 90 degrees in the normal and reverse directions, respectively, to uncover the screen of the display panel outside an edge of the main body enclosure.

6. The electronic apparatus according to claim 5, wherein the specific angle positions are shifted from the reference angle position by ±45 degrees, respectively.

7. The electronic apparatus according to claim 5, wherein the hinge bracket has a contour aligned with a contour of the display enclosure when the display enclosure is set at any of the specific angle positions during establishment of the closed attitude of the hinge bracket.

8. The electronic apparatus according to claim 5, further comprising:
a magnet attached to one of the hinge bracket and the display enclosure;
a magnetic force sensor attached to other of the hinge bracket and the display enclosure, the magnetic force sensor opposed to the magnet when the display enclosure is set at the specific angle position during establishment of the closed attitude of the hinge bracket; and
a controller circuit outputting an instruction signal to clear display on the screen of the display panel when the controller circuit detects the display panel set at the reference angle position during establishment of the closed attitude of the hinge bracket in response to output from the magnetic force sensor, the controller circuit outputting an instruction signal to make a specific display appear on an uncovered screen of the display panel outside the edge of the main body enclosure when the controller circuit detects the display enclosure set at the specific angle position during establishment of the closed attitude of the hinge bracket in response to output from the magnetic force sensor.

9. An electronic apparatus comprising:
a main body enclosure;
a display enclosure superposed on a flat front surface of the main body enclosure on a front surface, the display enclosure defining a window opening in the front surface for exposing a screen of a display panel;
a first coupling mechanism coupling the display enclosure to the main body enclosure for relative rotation around a first rotation axis parallel to the flat front surface of the main body enclosure, the first coupling mechanism allowing change of an attitude of the display enclosure from a closed attitude, where the display enclosure is superposed on the flat front surface of the main body enclosure, to an opened attitude, where the display enclosure is flipped to open relative to the main body enclosure through rotation around the first rotation axis; and
a second coupling mechanism coupling the display enclosure to the main body enclosure for relative rotation around a second rotation axis perpendicular to the flat front surface of the main body enclosure when the display enclosure takes the closed attitude, the second coupling mechanism allowing rotation of the display enclosure around the second rotation axis at least over a range of 90 degrees from a reference angle position where the window opening of the display enclosure is entirely covered with the main body enclosure, the second coupling mechanism restraining the rotation of the display enclosure at a specific angle position shifted from the reference angle position by an angle smaller than 90 degrees, to uncover the screen of the display panel outside an edge of the main body enclosure.

10. An electronic apparatus comprising:
a main body enclosure;
an auxiliary enclosure superposed on a flat front surface of the main body enclosure on a front surface, the auxiliary enclosure defining a window opening;
a hinge bracket coupled to the main body enclosure for relative rotation around a first rotation axis parallel to the flat front surface of the main body enclosure, the hinge bracket receiving a back surface of the auxiliary enclosure on a front surface, the hinge bracket allowed to change from a closed attitude, where the auxiliary enclosure is superposed on the flat front surface of the main body enclosure, to an opened attitude, where the auxiliary enclosure is flipped to open relative to the main body enclosure through rotation around the first rotation axis; and
a coupling mechanism coupling the auxiliary enclosure to the hinge bracket for relative rotation around a second rotation axis perpendicular to the flat front surface of the main body enclosure when the hinge bracket takes the closed attitude, the coupling mechanism allowing rotation of the auxiliary enclosure around the second rotation axis at least over a range of 90 degrees from a reference angle position where the window opening of the auxiliary enclosure is entirely covered with the main body enclosure, the coupling mechanism restraining the rotation of the auxiliary enclosure around the second rotation axis at a specific angle position shifted from the reference angle position by an angle smaller than 90 degrees.
